(19) United States
(12) Patent Application Publication
(10) Pub. No.: US 2021/0158188 A1
(43) Pub. Date: May 27, 2021

(54) RECOMMENDING NEWS IN CONVERSATION

(71) Applicant: MICROSOFT TECHNOLOGY LICENSING, LLC, Redmond, WA (US)

(72) Inventors: Qing ZHOU, Redmond, WA (US); Jie ZHANG, Dongcheng District (CN); Peng CHEN, Redmond, WA (US); Jianyong WANG, Redmond, WA (US); Wei WANG, Redmond, WA (US); Ting SUN, Redmond, WA (US)

(73) Assignee: Microsoft Technology Licensing, LLC, Redmond, WA (US)

(21) Appl. No.: 17/044,234

(22) PCT Filed: Apr. 26, 2019
(86) PCT No.: PCT/US2019/029245

§ 371 Date: Sep. 30, 2020

(30) Foreign Application Priority Data
May 11, 2018 (CN) 201810449396.6

(51) Int. Cl. G06N 5/04; G06N 20/00; G06F 16/9535

(52) U.S. Cl. CPC G06N 5/04; G06F 16/9535; G06N 20/00

(57) ABSTRACT

The present disclosure discloses a technique of recommending news in conversation. The technique may recommend news in a conversation with respect to the case that a user may be interested in some news event during a conversation, so that the user's interests in reading news may be found during the conversation, and provides the user with related new information on news in a form of chatting reply at appropriate time.

### BACKGROUND

During a conversation between a chatbot and a user, subjects related to some hot news events may usually be involved. Under the circumstance, some users may be interested in related news, and would like to read related news to know something about the hot news events.

### BRIEF SUMMARY

The embodiments of the present disclosure are provided to give a brief introduction to some concepts, which would be further explained in the following description. This

Summary is not intended to identify essential technical features or important features of the subject as claimed nor to limit the scope of the subject as claimed.

The embodiments of the present disclosure may provide a technique for recommending news in a conversation with respect to the case that a user may be interested in some news event during a conversation, so that the user's interests in reading news may be found during the conversation, and provides the user with related new information on news in a form of chatting reply at appropriate time.

The above description is merely a brief introduction of the technical solutions of the present disclosure, so that the technical means of the present disclosure may be clearly understood, and implemented according to the description of the specification, and the above and other technical objects, features and advantages of the present disclosure may be more obvious based on the embodiments of the present disclosure as follows.

### BRIEF DESCRIPTION OF THE DRAWINGS

FIG. 1 is a block diagram showing an illustrative environment of a news conversation processing device;

FIG. 2 is an illustrative block diagram showing a structure of a news conversation processing device;

FIG. 3 is an illustrative block diagram showing a structure of a news conversation processing device;

FIG. 4 is an illustrative block diagram showing a structure of a news conversation processing device;

FIG. 5 is an illustrative block diagram showing a structure of a news conversation processing device;

FIG. 6 is an illustrative block diagram showing a structure of a news conversation processing device;

FIG. 7 is a schematic flowchart showing an exemplary news conversation processing method;

FIG. 8 is a schematic flowchart showing an exemplary news conversation processing method;

FIG. 9 is a schematic flowchart showing an exemplary news conversation processing method;

FIG. 10 is a schematic flowchart showing an exemplary news conversation processing method;

FIG. 11 is a structural block diagram of an exemplary mobile electronic apparatus; and

FIG. 12 is a structural block diagram of an exemplary computing apparatus.

### DETAILED DESCRIPTION

In the following, description will be given in detail on the exemplary embodiments of the present disclosure, in connection with the accompanying drawing. Although drawings show the exemplary embodiments of the present disclosure, it should be appreciated that the present disclosure may be implemented in various ways without being limited by the embodiments set forth herein. On the contrary, these embodiments are provided for thorough understanding of the present disclosure, and completely conveying the scope of the present disclosure to the skills in the art.

The following description sets forth various examples along with specific details to provide a thorough understanding of claimed subject matter. It will be understood by those skilled in the art, however, the claimed subject matter may be practiced without some or more of the specific details disclosed herein. Further, in some circumstances, well-known methods, procedures, systems, components and/or circuits have not been described in detail in order to avoid unnecessarily obscuring claimed subject matter.

In the following detailed description, reference is made to the accompanying drawings, which form a part hereof.

In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

It will be readily understood that the aspects of the present disclosure, as generally described herein, and illustrated in the figures, can be arranged, substituted, combined, and designed in a wide variety of different configurations, all of which are explicitly contemplated and make part of this disclosure.

The term “technique”, as cited herein, for instance, may refer to system(s), method(s), computer-readable instructions, module(s), algorithms, hardware logic (e.g., Field-programmable Gate Arrays (FPGAs), Application-specific Integrated Circuits (ASICs), Application-specific Standard Products (AS SPs), System-on-a-chip systems (SOCs), Complex Programmable Logic Devices (CPLDs)), and/or other technique(s) as permitted by the context above and throughout the document.

Overview

The embodiments of the present disclosure may provide a technique for recommending news in a conversation with respect to the case that a user may be interested in some news event during a conversation, so that the user's interests in reading news may be found during the conversation, and provides the user with related new information on news in a form of chatting reply at appropriate time.

The user's interests in reading news may be mainly found by analyzing a user's query and a chat log of relevant context, and information on news may be acquired by performing search on the network or in a local news database based on the user's query. When a chat reply is made, a document of news or a news content link may be simply used as a reply, and a reply may be also made in the form of a news summary. In addition, a news comment may be attached in the form of a chat reply, so that news contents may be provided to users in a more anthropomorphic way.

Illustrative Environment

The environment described below may merely construct an example without limiting claims of the present disclosure to any specific operating environment and other environment may be used without departing from the spirit and range as claimed by the present disclosure.

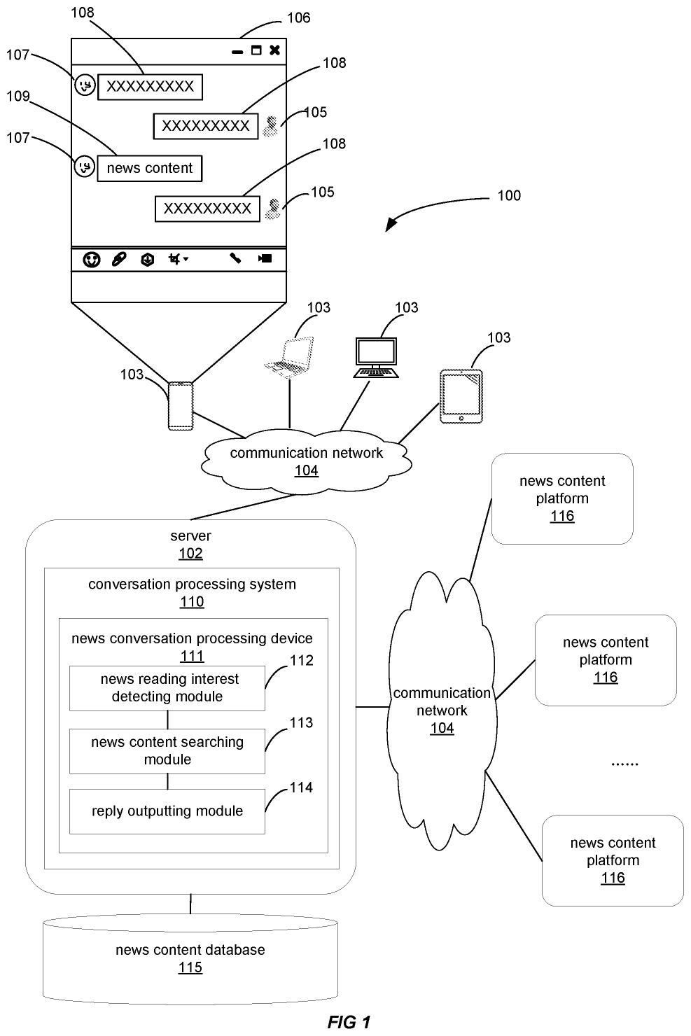

As shown in FIG. 1, which is a block diagram 100 of an exemplary environment of a news conversation processing device, the news conversation processing device 111 may be provided in a server 102, and the server 102 may be connected to a user terminal 103 through a communication network 104. The user terminal 103 may be a small portable (or mobile) electronic apparatus. The small portable (or mobile) electronic apparatus may be e.g., a cell phone, a personal digital assistant (PDA), a personal media player device, a wireless network player device, personal headset device, an IoT (internet of things) intelligent device, a dedicate device or combined device containing any of functions described above. The user terminal 103 may be implemented as computing apparatus such as desktop computer, dedicated server. A chatting application for man-machine conversation may be installed in the user terminal 103 and a user 105 may conduct man-machine conversation with a chatbot 107 through a conversation interface 106 provided by the chatting application. In the exemplary conversation interface 106 as shown in FIG. 1, a user 105 may conduct a man-machine conversation with a chatbot 107, and the conversation content of the man-machine conversation between the user 105 and the chatbot 107 may involve a general conversation content 108 and a pushed news content 109. In the schematic scenario shown in the figure, some hot news is mentioned during the chatting between the user 105 and the chatbot 107. The chatbot 107 may perform analyzing on the conversation content of the user 105, acquire the news content 109 related to the hot news mentioned by the user 105 during the conversation, and presents the news content to the user 105 through the conversation interface 106.

The analyzing on the conversation content and the acquiring of the news content may be done in the server 102. After acquiring the news content, the server 102 may push the news content to the user 105 through the chatting application on the user terminal 103.

The server 102 may be implemented via one or more computer systems (distributed server), and may also be implemented as a cloud server of a cloud-based framework. A conversation processing system 110 providing background conversation support for the chatbot 107 may be provided on the server 102. The conversation processing system 110 can at least perform a basic conversation processing function of generating a reply to a user's query input by the user in the conversation. The news conversation processing device 111 provided herein may be embedded in the conversation processing system 110 as a part of the conversation processing system 110 to perform the processing function of recommending news. The news conversation processing device 111 includes a news reading interest detecting module 112, a news content searching module 113, and a reply outputting module 114.

More particularly, the news reading interest detecting module 112 may be configured to detect an interest in reading news on user's at least one query during a conversation.

The interest in reading news cited herein may be a conversation intention for which a user explicitly or probably wants to know about related news or a conversation intention reflecting a user's interest in related news. For example, a user may input a user's query of “I would like to watch news about today's game of Real Madrid” or “do you know about the result of the today's game of Real Madrid today”. According to semantic analysis, the user's query explicitly shows that the user wants information related to news about the game of Real Madrid. In another example, during a conversation between a user and a chatbot, the user mentions that “I extremely like Real Madrid” and “I'm a big fan of Real Madrid”. In this case, the user may be regarded as being very interested in Real Madrid, and probably want to have information related to Real Madrid. In view of this, it may be considered that the user has an interest in reading news. In another example, a user inputs some queries highly similar with news contents stored in a news content database during a conversation.

When the similarities of user's these queries with respect to the news contents are higher than some threshold, the user may be recognized as having an interest in reading news. A condition for determining the interest in reading news may be flexibly set according to the needs for practical application.

Detection of an interest in reading news with respect to a user's query may be performed by using a machine learning model. A user's current query or a context containing the user's current query may be used as an input to the machine learning model to determine whether or not the user has an interest in reading news.

More particularly, when a user's new query is received from a user, analyzing may be performed on user's query to determine whether the user's query can form a complete news reading interest. On one hand, if the user's query has formed a complete news reading interest. For example, regarding the expression of “I would like to read news about today's game of Real Madrid” in the above example, subsequent searching for the news content may be performed with respect to such a user's query with an explicit intention. On the other hand, in some cases, it may be very difficult to determine whether or not a user has an interest in reading news based on a user's query. For example, a user inputs a user's query of “Why does everyone like Real Madrid so much”. With respect to such user's query, it may be impossible to find out whether or not the user likes Real Madrid, or whether or not the user has interest in news about Real Madrid. It may be possible that the user is not a fan of football, and thus has no idea on why other people like Real Madrid. It may be possible that the user is a fan of football, but doesn't like Real Madrid. Under the circumstance, it is obvious that news about Real Madrid shouldn't be pushed to the user. However, it may be also possible that the user has begun to like Real Madrid, and would like to know more about Real Madrid. If so, information related to Real Madrid should be pushed to the user. In view of the above circumstances, it may be impossible to determine whether or not the user has a complete and explicit interest in reading news at the current stage, so it is necessary to determine whether or not the user has an interest in reading news by further using the history of user's queries in the chatting log. For example, in a chatting log, the user's last query is “My good friend starts to like Real Madrid, so I start to pay attention to Real Madrid, too”. Combining the user's this query with “Why does everyone like Real Madrid so much”, it may be known that the user would actually like to know more information related to Real Madrid, and thus it may be determined that the user has an interest in reading news. In another example, in a chatting log, the user's last query is that “I feel boring because all surrounding people are talking about Real Madrid”. Bu combining the user's this query with “Why does everyone like Real Madrid so much”, it may be known that the user is actually complaining that too many people talk about Real Madrid, and does not like Real Madrid, so that the user would not like news about Real Madrid. Therefore, it may be determined that the user has no interest in reading news. Of course, there may be a situation that it is still not enough to determine whether or not a user has an interest in reading news by combining the user's current query and the history of the user's queries. In this case, the user's current query may be recorded in a chatting log, and a detection may be performed for next round until a user's new query is input. In the detection of interest in reading news of next round, the user's query of last round may be used as the history of user's queries. Based on such determining mechanism, detection of interest in reading news for a plurality of rounds may be performed.

In the above detection of the interest in reading news, if it is impossible to determine whether or not a user has an interest in reading news or it is determined that a user has no interest in reading news, a reply may be made in a normal chatting mode. That is to say, a normal reply is generated by using a normal reply generating mode in the conversation processing system 110 shown in FIG. 1, so that the conversation may be continued. For example, a replay such as “many people do like Real Madrid” may be made with respect to “why does everyone like Real Madrid so much”. It should be noted that, instead of the normal reply generating mode, any other reply mode for generating a reply in a form of news cited herein may be used, and there is no limitation thereon.

The news content searching module 113 may be configured to search for a news content according to a user's query related to the interest in reading news when an interest in reading news is found.

The source of news content may be a service provider providing a serving application of a chatbot 107, e.g., the news content source may be stored in a news content database 115 connected with the server 102. The news content database 115 may be maintained by the service provider. A news document carrying a news content may be generated in the way of acquiring online or offline, or manually by human beings. Operations such as editing, tagging may be performed on the news document as required, to facilitate the searching for news contents.

The source of the news content may be a third-party news content platform other than the service provider. The server 102 may be connected with various news content platforms 116 through the communication network 104, and perform searching in the news content platforms 116 online to acquire news contents.

More particularly, the searching for the news content using the user's query may include the following steps:

Searching may be performed for the news content according to the user's query related to the interest in reading news, and a plurality of news contents related to the user's query may be acquired. The user's query related to the interest in reading news cited herein may only include a user's current query, and may include the user's current query and a history of user's queries. As mentioned above, when a user's current query fails to reflect a complete interest in reading news, it may be necessary to determine whether or not the user has an interest in reading news according to the user's current query and the history of user's queries.

A relevancy ranking algorithm may be used for relevancy ranking on the plurality of news contents. The relevancy cited herein may refer to relevancy between the news content and a user's query. With the processing using the relevancy ranking algorithm, a news content matching with a user's intention more may be acquired.

One or more news contents with high relevancy rankings may be output as a reply in the conversation. Depending on specific circumstances, a user may be provided with only one piece of news content, or provided with a plurality of pieces of news contents.

The reply outputting module 114 may be configured to output the acquired news content as a reply in the conversation. As mentioned above, when a news content to be output is determined, the news content to be output may be output by the reply outputting module 114. The news content may be output in various forms such as outputting a news content into a conversation in a form of webpage link. More particularly, the webpage link of the news content may be generated as a thumbnail expression of news containing thumbnail view of news and title of news. When a user clicks the thumbnail view of news, the webpage of related news content may be shown.

In another example, a news content may be output in a way which may make the users have more feeling of conversation. More particularly, information may be extracted from the found news content, so as to generate a summary of news and output the summary of news as a reply in the conversation. That is to say, it seems like that the chatbot 107 gives a brief introduction of news to the user 105, so that the conversation may be more like a chatting between human beings. Furthermore, the summary may be output into a conversation as a part of the above webpage link of news, i.e., the above thumbnail expression of news may contain the summary of news therein.

In another example, besides the above thumbnail expression of news or summary of news, a comment on news may be further provided with the news. More particularly, a comment on news may be acquired as follows: searching for a comments on news according to the found news content and the user's related query, and outputting the acquired comment on news as a reply in the conversation. A comment on news may be from the news content platform 116.

In addition, under a subject of news, the chatbot 107 may provide comments on news so as to perform chatting for a plurality of rounds, i.e., the chatbot 107 and the user 105 may perform a conversation for a plurality of rounds with respect to such subject of news. During the conversation of a plurality of rounds, the chatbot 107 may always acquire comments on news from the news content platform 116 as replies, and use the current news content and the user's query of current round as the input for the searching whenever acquiring a comment on news. The above conversation processing by using the comments on news may be performed for one round or a plurality of rounds. Such conversation may be terminated when a preset number of rounds is arrived and/or the subject of a user's query input by the user 105 has been changed. If a specified number of rounds is reached or the subject of news has been changed, the mode of providing a reply with a comment on news is terminated and changed to the conventional reply generating mode in the conversation processing system 110 to generate a reply and output the reply in the conversation.

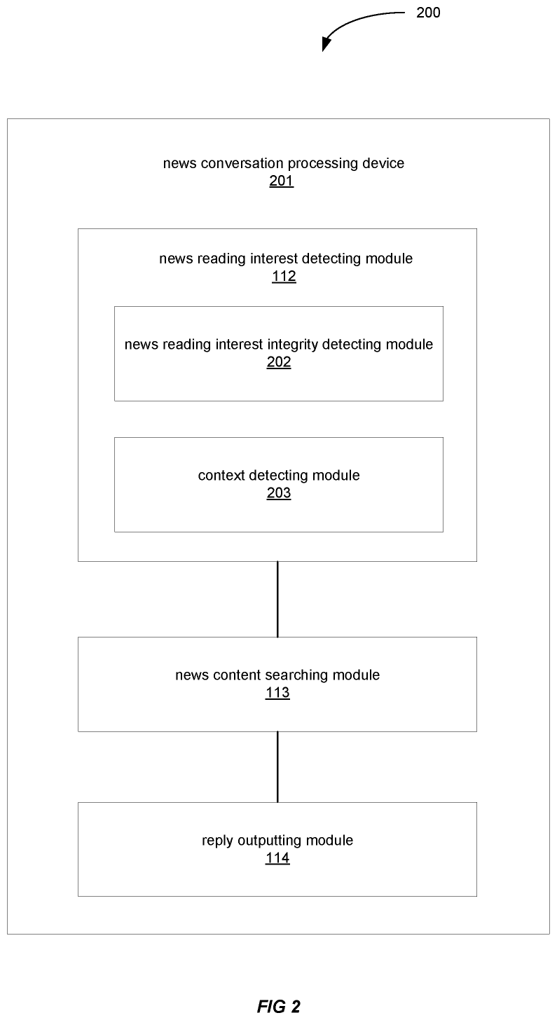

As shown in FIG. 2, which is an illustrative block diagram 200 showing a structure of a news conversation processing device, the news conversation processing device 201 shown in FIG. 2 is same as the news conversation processing device shown in FIG. 1, except that a news reading interest detecting module 112 may further include a news reading interest integrity detecting module 202 and a context detecting module 203.

The news reading interest integrity detecting module 202 may be configured to perform analyzing on the user's current query and determine whether or not the interest in reading news is found. The news content searching module 113 may perform the searching for the news content according to the user's current query, if it is determined that the interest in reading news is found. If it is determined that there is no interest in reading news found, the context detecting module 203 may perform processing correspondingly.

The context detecting module 203 may be configured to acquire a history of user's queries from a first chatting log, determine whether or not the interest in reading news may be found based on a combination of the user's current query and the history of user's queries, if it is determined that there is no interest in reading news based on the user's current query.

The news content searching module 113 may perform searching for the news content based on the combination of the user's current query and the history of user's queries, if it is determined that the interest in reading news is found.

In the news conversation processing device 201, processing of detection of an interest in reading news may be implemented by the news reading interest integrity detecting module 202 and the context detecting module 203 for a plurality of rounds so as to cover the context, and thus a user's intention to acquire news may be effectively obtained.

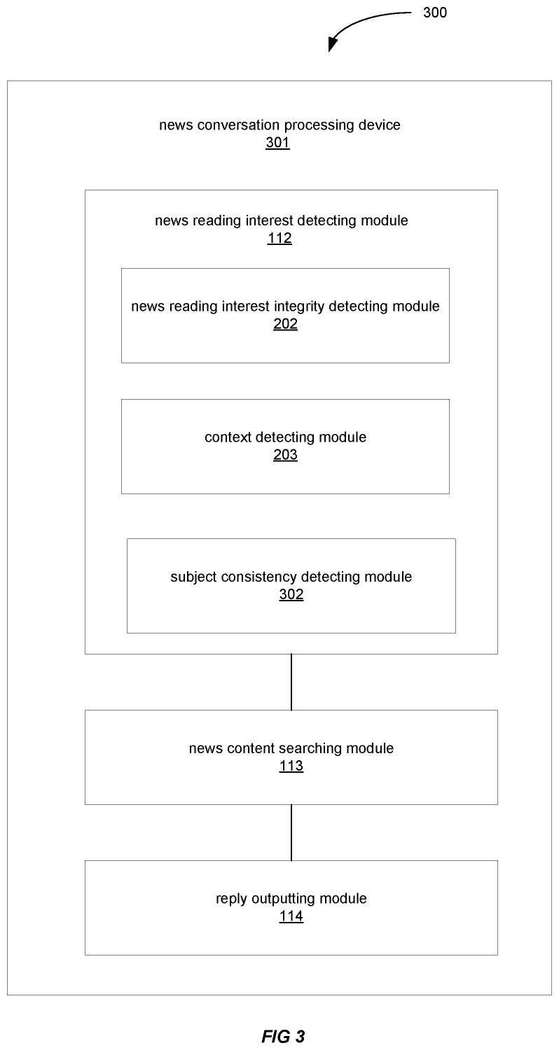

Furthermore, as shown in FIG. 3, which is an illustrative block diagram 300 showing a structure of a news conversation processing device, the news conversation processing device 301 shown in FIG. 3 may be same as the news conversation processing device 201 shown in FIG. 2, except that the news reading interest detecting module 112 may further include a subject consistency detecting module 302.

The subject consistency detecting module 302 may be configured to detect whether or not a subject of the user's current query and a subject of the history of user's queries meet a similarity condition. The context detecting module 203 may perform the processing of determining whether or not the interest in reading news is found based on a combination of the user's current query and the history of user's queries, if it is determined that the subject of the user's current query and the subject of the history of user's query meet the similarity condition. On the other hand, the user's current query may be recorded in the first chatting log and the processing should be suspended until a user's new query is input, if it is determined that the subject of the user's current query and the subject of the history of user's query fail to meet the similarity condition.

In the news conversation processing device 301 shown in FIG. 3, the subject consistency detecting module 302 may be configured to control whether or not the detection of interest in reading news is performed in conjunction with a context. In a conversation, if a user changes a subject of chatting, it may be considered that the user's current query is not a continuation of a user's previous query, and it may be unnecessary to find an interest in reading news based on the context, and the detecting of an interest in reading news may be proceeded with the user's current query as a start of a new subject.

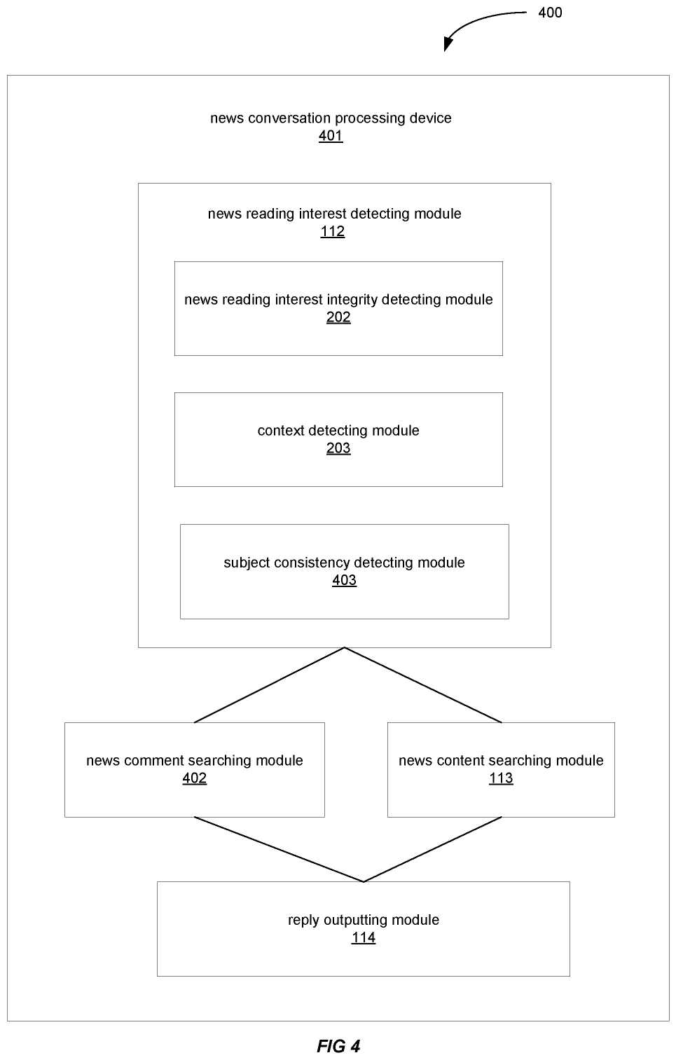

Furthermore, the subject consistency detecting module may be further configured to control a mechanism of replying for a plurality of rounds with a comment on news. More particularly, as shown in FIG. 4, which is an illustrative block diagram 400 showing a structure of a news conversation processing device, the news conversation processing device 401 shown in FIG. 4 is same as the news conversation processing device 301 shown in FIG. 3, except that the news conversation processing device 401 shown in FIG. 4 further includes a news comment searching module 402.

The news comment searching module 402 may be configured to search for a comment on news according to the found news content and the user's related query. Accordingly, the reply outputting module 114 is further configured to output the acquired comment on news as a reply in the conversation.

Furthermore, in FIG. 4, the subject consistency detecting module 403 may be further configured to receive a user's new query, detect whether or not a subject of the user's new query and a subject of a user's last query meet a subject similarity condition (or referred to as a subject consistency condition). The news comment searching module 402 may perform searching for a new news comment according to the user's new query and the news content, if it is determined that the subject of the user's new query and the subject of the user's last query meet the subject similarity condition. The reply outputting module 114 may output the acquired new news comment as a reply in the conversation.

Then the news conversation processing device 401 may continue to wait for an input of a user's new query of the next round, repeat the above processing of subject consistency detection, and continue the conversation with the user with a news comment as an output, until a preset number of rounds is reached or the subject similarity condition is not met (i.e., the user changes a subject).

In FIG. 4, upon the reply outputting module 114 outputs a comment on news of the first round, a mode of outputting a comment on news as reply may be launched. In such mode, the target of the subject consistency detection may be changed to detect whether or not the news comment replying mode should be continued, so that a deep chatting between the user 105 and the chatbot 107 may be conducted under the subject of news.

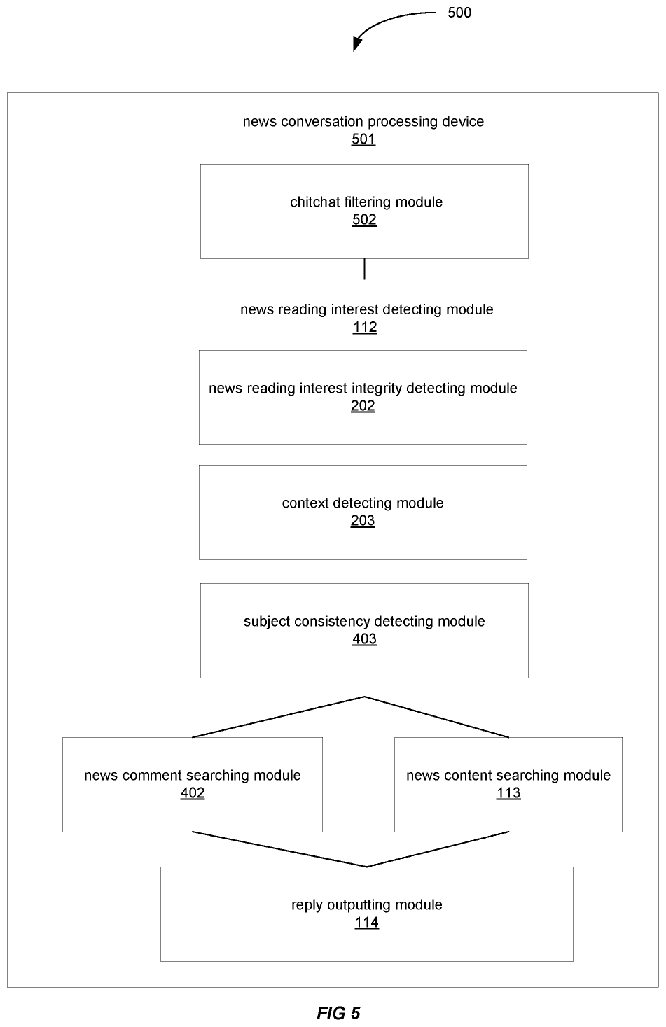

Furthermore, as shown in FIG. 5, which is an illustrative block diagram 500 showing a structure of a news conversation processing device 501, the news conversation processing device 501 shown in FIG. 5 is same as the news conversation processing device shown in FIG. 1 to FIG. 4, except that the news conversation processing device 501 shown in FIG. 5 further includes a chitchat filtering module 502.

The chitchat filtering module 502 may be configured to perform chitchat filtering on the received user's query. The news reading interest detecting module may perform the detecting of an interest in reading news with respect to user's at least one query, if it is determined that the received user's query is not a chitchat. If it is determined that the received user's query is a chitchat, the news conversation processing mechanism provided herein will not be performed, but a conventional reply may be generated directly by using a conversation processing module other than the news conversation device of the conversation processing system 110 shown in FIG. 1 (i.e., using a conventional reply mode) so that the conversation may be continued. The chitchat cited herein is a relative concept, and may be semantically set as required. For example, if user's queries are “today I am in a good mood”, “I just have had enough” or the like, the contents of the user's queries are irrelevant to subjects of news, and the user's queries may be regarded as user's queries of chitchat. With respect to such user's queries, replies may be generated using the conversation processing module other than the news conversation device of the conversation processing system 110.

The chitchat filtering module 502 is provided to effectively filter some user's queries meaningless to a news conversation, so as to decrease the number of user's queries processed by the news conversation processing device herein. In addition, the above first chatting log may be a regular chatting log which have not been subject to processing or selection, or a special chatting log provided for the news conversation processing herein. The user's queries recorded in the first chatting log may be user's queries which are subjected to the filtering processing by the chitchat filtering module 502 to provide a more effective context for the detection on interest in reading news.

It should be noted that FIG. 5 shows all modules shown in FIG. 4. However, the chitchat filtering module 502 may be combined with other modules shown in FIG. 1 to FIG. 3 in various forms to form other various structures of the news conversation processing device.

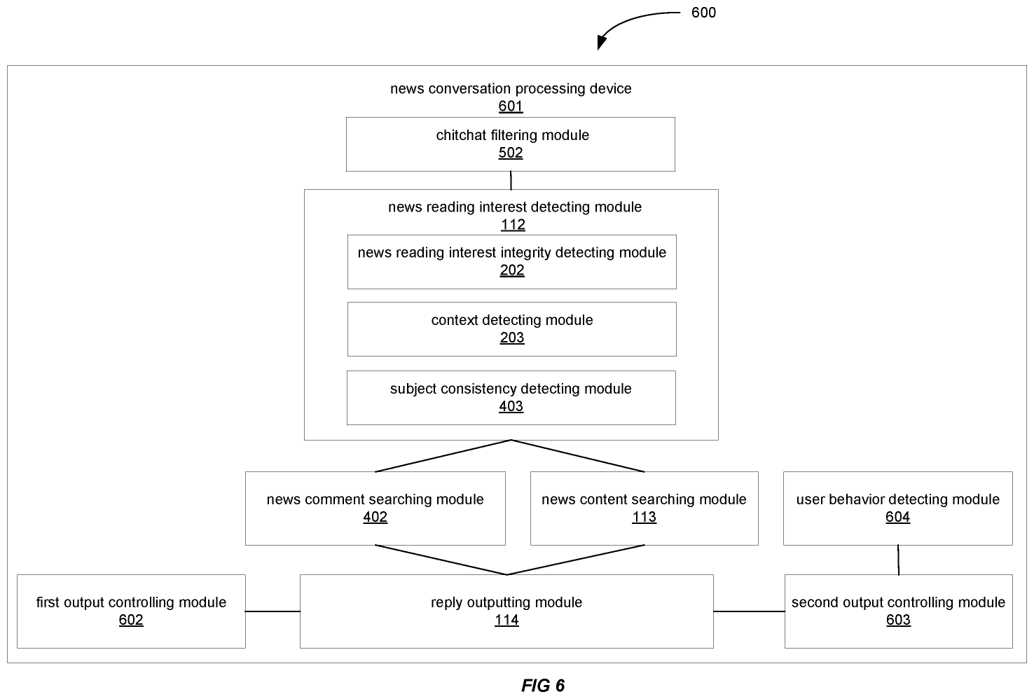

Furthermore, as shown in FIG. 6, which is an illustrative block diagram 600 showing a structure of a news conversation processing device 601, the news conversation processing device 601 shown in FIG. 6 is same as the news conversation processing devices shown in FIG. 1 to FIG. 5, except that the news conversation processing device 601 shown in FIG. 6 further includes a processing modules for controlling frequency for outputting news replies. More particularly, the news conversation processing device 601 may include a first output controlling module 602 and a second output controlling module 603.

The first output controlling module 602 may be configured to compare the found news content with documents previously output in the conversation to determine whether or not a content similarity of a news content is greater than a preset first threshold, and discard a news content to be output as a reply in the conversation if the content similarity of the news content is greater than a preset first threshold, or control the reply outputting module to output the news content having a content similarity equal to or smaller than a preset first threshold as a reply in the conversation. The first output controlling module 602 is provided to avoid pushing redundant news content to a user.

The second output controlling module 603 may be configured to determine whether or not a number and/or a frequency for outputting news contents is above a preset second threshold, and discard a news content to be output as a reply in the conversation if the number and/or the frequency for outputting the news content is above the preset second threshold, or control the reply outputting module to output the news content as a reply in the conversation if the number and/or the frequency for outputting the news content is not above the preset second threshold. The second output controlling module 603 is provided to control a frequency for outputting the pushed news contents, and avoid outputting excessive news content replies in the conversation. The second threshold may be set as a constant value as needed, or be dynamically adjusted by a user behavior detecting module 604 described below according to the user's using behavior.

Furthermore, the news conversation processing device 601 may further include a user behavior detecting module 604. The user behavior detecting module 604 may be configured to record a quantity of viewed news contents and/or a reading time for reading the news contents, and adjust the second threshold according to the quantity of viewed news contents and/or the reading time for reading the news contents. The news conversation processing device 601 is provided to adjust a frequency for outputting the pushed news contents according to a user's behavior. For example, in a conversation between the user 105 and the chatbot 107, the user 105 clicks almost all links to news content sent to the user 105 by the chatbot 107, and stays for an enough long time on the webpages corresponding to the clicked links to the news content (which may indicate that the user 105 is reading the news carefully). It may be inferred that the user is very interested in the news contents. Therefore, the second threshold may be increased, and more news content may be output as replies in the conversation. Otherwise, if the user seldom clicks links to news content, or stays for a very short time after clicking a link to news content, it may be inferred that the user does not like a pushed news content. Therefore, the second threshold may be decreased, and thus the frequency for outputting news content as replies may be decreased.

The news conversation processing device 601 cited herein may only include the first output controlling module 602 or the second output controlling module 603. That is to say, it is unnecessary for the news conversation processing device 601 to include both of the first output controlling module 602 and the second output controlling module 603.

It should be noted that FIG. 6 shows all modules in FIG. 5. However, the first output controlling module 602, the second output controlling module 603 and the user behavior detecting module 604 may be combined with other modules shown in FIG. 1 to FIG. 5 in various forms to form other various structures of the news conversation processing device.

Illustrative Process

Description has been made on the news conversation processing device above. Explanation would be made on news conversation processing method cited herein below.

Description on Processing Flow of Basic News Conversation

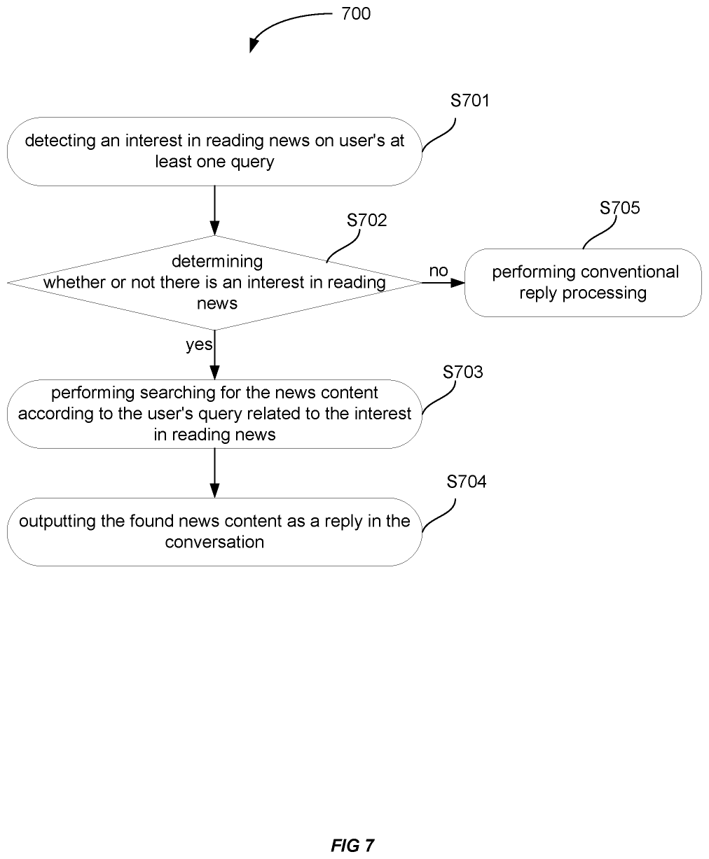

As shown in FIG. 7, which is a schematic flowchart 700 showing an exemplary news conversation processing method, the processing may include the following steps.

S701: detecting an interest in reading news on user's at least one query during a conversation.

S702: determining whether or not there is an interest in reading news, and turning to the step of S703, if it is determined that there is an interest in reading news, or turning to the step of S705, if it is determined that there is no interest in reading news found.

S703: performing searching for the news content according to the user's query related to the interest in reading news.

S704: outputting the found news content as a reply in the conversation. The news content may be output in a way of outputting a news content into a conversation in a form of webpage link, or in a way of generating a thumbnail expression of the webpage link of news including an thumbnail view and a news title. Upon a user clicks the thumbnail view of news, a related webpage of news content may be shown. Furthermore, information may be extracted from a found news content to generate a summary of news, and the summary of news may be output as a reply in the conversation. Furthermore, a comment on news may be further provided with the news in addition to the above thumbnail expression of news or summary of news.

S705: performing conventional reply processing. The conventional reply processing cited herein refers to generating a general reply according to the processing mechanism of the conversation processing system of the chatbot and outputting the general reply, rather than generating a reply using a news content reply mode. This processing may be performed by a related system or module that performs general conversation processing in the conversation processing system 110 shown in FIG. 1.

The news conversation processing shown in FIG. 7 performs the basic processing flows including detecting an interest in reading news, acquiring a news content, and outputting the news content. In the processing flow of searching for a news content, the news content may be from news content data of a service provider of a service application of a chatbot, and may be from a third-party news content platform other than the service provider.

In the process of searching for news, a relevancy ranking algorithm may be used for relevancy ranking on a plurality of news contents, so that a news content matching a user's intention more may be selected.

Description on Processing Flow of Context Detection

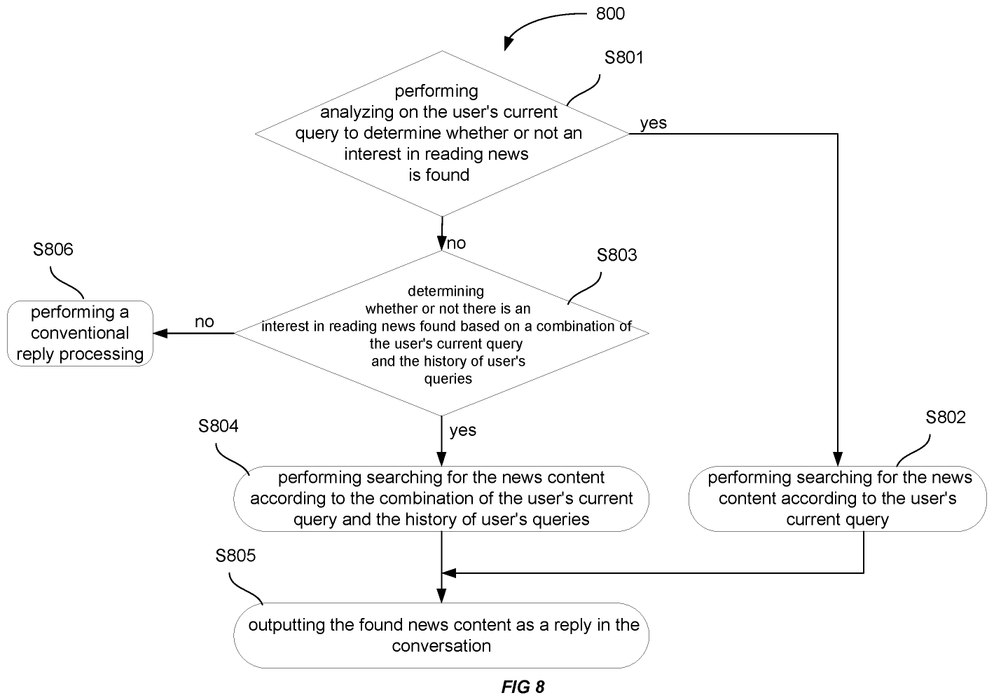

As shown in FIG. 8, which is a schematic flowchart 800 showing an exemplary news conversation processing method, the processing shown in FIG. 8 includes the following steps.

5801: performing analyzing on the user's current query to determine whether or not an interest in reading news is found, and turning to the step of S802, if it is determined that the interest in reading news is found; or turning to the step of S803, if it is determined that there is no interest in reading news found;

S802: performing searching for the news content according to the user's current query, and then turning to the step of S805;

S803: acquiring a history of user's queries from a first chatting log, determining whether or not there is an interest in reading news found based on a combination of the user's current query and the history of user's queries, and turning to the step of S804, if it is determined that the interest in reading news is found, or turning to the step of S806, if it is determined that there is no interest in reading news found;

S804: performing searching for the news content according to the combination of the user's current query and the history of user's queries;

S805: outputting the found news content as a reply in the conversation; and

S806: recording the user's current query in the first chatting log, performing a conventional reply processing, and then waiting for a user's new query.

In the news conversation processing shown in FIG. 8, a context detecting mechanism is further used. When the user's current query fails to reflect a complete interest in reading news, a context is further used for further determination, so as to realize detection of a interest in reading news which may be performed for a plurality of rounds and cover the context, and a user's intention to acquire news may be effectively found.

Description on Processing Flow of Topic Consistency Detection

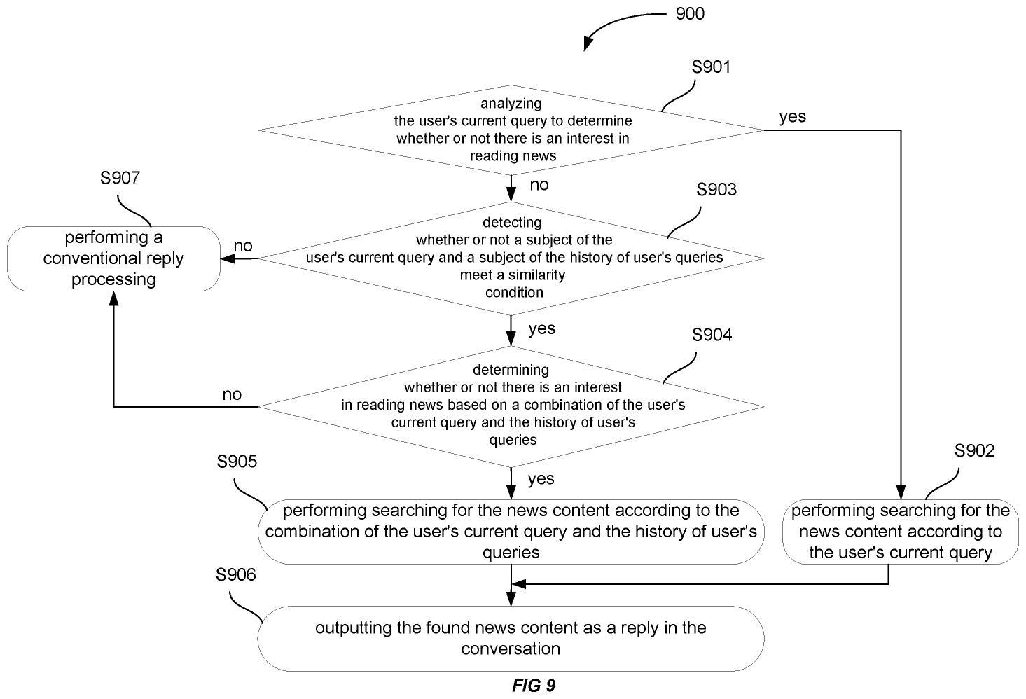

As shown in FIG. 9, which is a schematic flowchart 900 showing an exemplary news conversation processing method, the conversation processing method may include the following steps.

S901: analyzing the user's current query to determine whether or not there is an interest in reading news, and turning to the step of S902, if it is determined that the interest in reading news is found; or turning to the step of S903, if it is determined that there is no interest in reading news found;

S902: performing searching for the news content according to the user's current query, and then turning to the step of S906;

S903: acquiring a history of user's queries from a first chatting log, detecting whether or not a subject of the user's current query and a subject of the history of user's queries meet a similarity condition, and turning to the step of S904, if it is determined that the subject of the user's current query and the subject of the history of user's queries meet a similarity condition; or turning to S907, if it is determined that the subject of the user's current query and the subject of the history of user's queries fail to meet the similarity condition;

S904: determining whether or not there is an interest in reading news based on a combination of the user's current query and the history of user's queries, and turning to the step of S905, if it is determined that there is an interest in reading news, or turning to the step of S907, if it is determined that there is no interest in reading news found;

S905: performing searching for the news content according to the combination of the user's current query and the history of user's queries;

S906: outputting the found news content as a reply in the conversation; and

S907: recording the user's current query in the first chatting log, performing a conventional reply processing, and then waiting for an input of a user's new query.

In the processing flow shown in FIG. 9, a subject consistency detecting mechanism may be further used for controlling whether or not to conduct the detection of an interest in reading news in conjunction with a context. In a conversation, if a user changes a chatting subject, it may be considered that the user's current query is not a continuation of a user's previous query, and thus it may be unnecessary to detect an interest in reading news based on the context, but the processing of detection on an interest in reading news may be conducted with the user's current query as a start of a new subject.

Description on Processing Flow of a Replying Mode with News Comment for a Plurality of Rounds

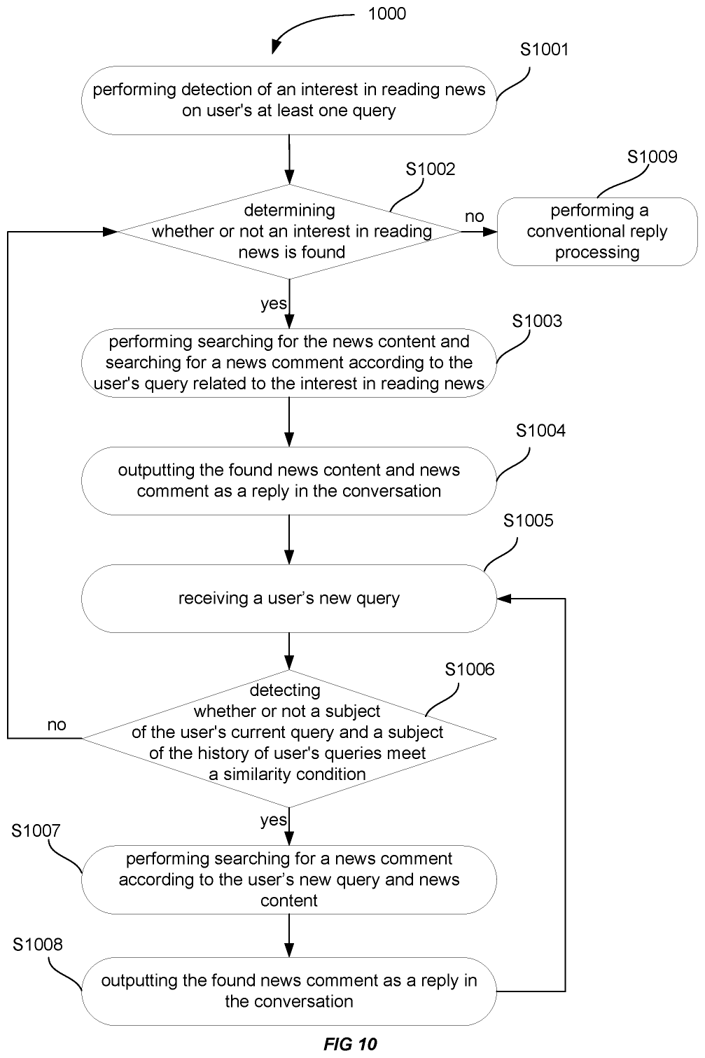

As shown in FIG. 10, which is a schematic flowchart 1000 showing an exemplary news conversation processing method, the processing flow shown in FIG. 10 is mainly used for illustrating a mechanism of performing replying with a news comment for a plurality of rounds. The news conversation processing method shown in FIG. 10 may include the following steps.

S1001: performing detection of an interest in reading news on user's at least one query during a conversation.

S1002: determining whether or not an interest in reading news is found, and turning to the step of S1003, if it is determined that the interest in reading news is found, or turning to the step of S1009, if it is determined that there is no interest in reading news found;

S1003: performing searching for the news content and searching for a news comment according to the user's query related to the interest in reading news;

S1004: outputting the found news content and news comment as a reply in the conversation;

S1005: receiving a user's new query;

S1006: acquiring a history of user's queries from a first chatting log, detecting whether or not a subject of the user's current query and a subject of the history of user's queries meet a similarity condition, and turning to the step of S1007, if it is determined that the subject of the user's current query and the subject of the history of user's queries meet a similarity condition; or turning to the step of S1002, if it is determined that the subject of the user's current query and the subject of the history of user's queries fail to meet the similarity condition;

S1007: performing searching for a news comment according to the user's new query and news content;

S1008: outputting the found news comment as a reply in the conversation, and then turning to the step of S1005; and

S1009: performing a conventional reply processing.

In the above processing flow, a replying mode with a news comment for a plurality of rounds may be consisted of the steps of S1005 to S1008, and the subject consistency detection is used to control whether or not to continue the news comment reply mode, so as to enable a deep chatting on a subject of news between the user and the chatbot. The above cycle may be terminated based on a preset number of rounds, and the step of S1002 may be performed when the news comment reply mode reaches the preset number of rounds.

It should be noted that the processing flow of a replying mode with a comment on news for a plurality of rounds shown in FIG. 10 may be combined with the processing flow shown in FIG. 8 and FIG. 9 to form various news conversation processing methods.

Description on Processing Flow of a Chitchat Filtering Mechanism

Furthermore, in the above processing flows, a chitchat filtering mechanism may be additionally included, i.e., after receiving a user's query, the user's query may be subjected to a processing of chitchat filtering. If it is determined that the received user's query is not a user's query of chitchat, the news conversation processing in the above processing flows may be performed. If it is determined that the received user's query is a user's query of chitchat, the news conversation processing mechanism provided herein would not be performed, but a conventional reply may be generated directly using a conversation processing module rather than the news conversation device of the conversation processing system 110 shown in FIG. 1 (i.e., the processing using a conventional reply mode) to continue the conversation.

The chitchat filtering mechanism is provided to effectively filter out some of user's queries meaningless to a news conversation, so as to reduce the number of user's queries processed by the news conversation processing device herein. In addition, the above first chatting log may be a special chatting log provided for the news conversation processing herein. The user's queries recorded in the first chatting log may be user's queries left after the processing of the chitchat filtering so as to provide a more effective context for detecting interest in reading news.

Description on Processing Flow of Frequency Controlling on Outputting News Content and Detecting Redundant Content

In order to avoid pushing redundant news content to a user, a redundant content determining mechanism may be further included in the above processing flows. More particularly, the processing flow of outputting the found news content as a reply in the conversation may include comparing the found news content with an output document in the conversation, and discarding the news content to be output as a reply in the conversation, if it is determined that there is a news content having a content similarity greater than a preset first threshold, and outputting the news content as a reply in the conversation, if it is determined that there is a news content having a content similarity smaller than or equal to a preset first threshold.

Moreover, in order to avoid outputting excessive news content replies in a conversation, frequency of outputting news contents may be under control. More particularly, the processing flow of outputting the found news content as a reply in the conversation may include: determining whether or not a number and/or a frequency for outputting the news contents exceeds a preset second threshold, and discarding the news content to be output as a reply in the conversation, if it is determined that the number and/or the frequency for outputting the news content exceeds the preset second threshold, and outputting the news content as a reply in the conversation, if it is determined that the number and/or the frequency for outputting the news content does not exceed the preset second threshold.

Furthermore, a frequency of pushing news contents may be adjusted according to a user's behavior, and a related threshold for controlling frequency may be dynamically adjusted according to reading behaviors on the pushed news contents by various users. More particularly, the news conversation processing flow herein may further include recording a quantity of read news content and/or a reading time of reading news contents, and adjusting the second threshold according to the quantity of read news content and/or the time of reading news contents .

It should be noted that the news conversation processing method may be implemented based on the news conversation processing device, or be implemented separately as a method process, or be designed by other software or hardware, and then be implemented based on the inventive concept herein.

Implementation Example of Electronic Apparatus

The electronic apparatus according to embodiments of the present disclosure may be a mobile electronic apparatus, or an electronic apparatus with less mobility or a stationary computing apparatus. The electronic apparatus according to embodiments of the present disclosure may at least include a processor and a memory. The memory may store instructions thereon and the processor may obtain instructions from the memory and execute the instructions to cause the electronic apparatus to perform operations.

In some examples, one or more components or modules and one or more steps as shown in FIG. 1 to FIG. 10 may be implemented by software, hardware, or in combination of software and hardware. For example, the above component or module and one or more steps may be implemented in system on chip (SoC). Soc may include: integrated circuit chip, including one or more of processing unit (such as center processing unit (CPU), micro controller, micro processing unit, digital signal processing unit (DSP) or the like), memory, one or more communication interface, and/or other circuit for performing its function and alternative embedded firmware.

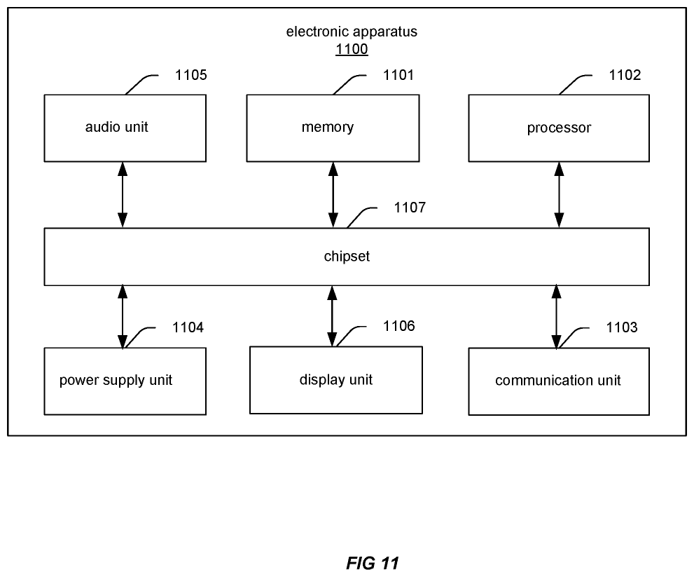

As shown in FIG. 11, which is a structural block diagram of an exemplary mobile electronic apparatus 1100. The electronic apparatus 1100 may be a small portable (or mobile) electronic apparatus. The small portable (or mobile) electronic apparatus may be e.g., a cell phone, a personal digital assistant (PDA), a personal media player device, a wireless network player device, personal headset device, an IoT (internet of things) intelligent device, a dedicate device or combined device containing any of functions described above. The electronic apparatus 1100 may at least include a memory 1101 and a processor 1102.

The memory 1101 may be configured to store programs. In addition to the above programs, the memory 1101 may be configured to store other data to support operations on the electronic apparatus 1100. The examples of these data may include instructions of any applications or methods operated on the electronic apparatus 1100, contact data, phone book data, messages, pictures, videos, and the like.

The memory 1101 may be implemented by any kind of volatile or nonvolatile storage device or their combinations, such as static random access memory (SRAM), electronically erasable programmable read-only memory (EEPROM), erasable programmable read-only memory (EPROM), programmable read-only memory (PROM), read-only memory (ROM), magnetic memory, flash memory, disk memory, or optical disk.

The memory 1101 may be coupled to the processor 1102 and contain instructions stored thereon. The instructions may cause the electronic apparatus 1100 to perform operations upon being executed by the processor 1102, the operations may include: implement the processing operations of the method of acquiring an entity webpage link shown in FIG. 7 to FIG. 10, or processing operations of the processing logics of the device of acquiring an entity webpage link shown in FIG. 1 to FIG. 6.

Detailed description has been made on the above operations in the above embodiments of method and device. The description on the above operations may be applied to electronic apparatus 1100. That is to say, the specific operations mentioned in the above embodiments may be recorded in memory 1101 in program and be performed by processor 1102.

Furthermore, as shown in FIG. 11, the electronic apparatus 1100 may further include: a communication unit 1103, a power supply unit 1104, an audio unit 1105, a display unit 1106, chipset 1107, and other units. Only part of units are exemplarily shown in FIG. 11 and it is obvious to one skilled in the art that the electronic apparatus 1100 only includes the units shown in FIG. 11.

The communication unit 1103 may be configured to facilitate wireless or wired communication between the electronic apparatus 1100 and other apparatuses. The electronic apparatus may be connected to wireless network based on communication standard, such as WiFi, 2G, 3G, or their combination. In an exemplary example, the communication unit 1103 may receive radio signal or radio related information from external radio management system via radio channel. In an exemplary example, the communication unit 1103 may further include near field communication (NFC) module for facilitating short-range communication. For example, the NFC module may be implemented with radio frequency identification (RFID) technology, Infrared data association (IrDA) technology, ultra wideband (UWB) technology, Bluetooth (BT) technology and other technologies.

The power supply unit 1104 may be configured to supply power to various units of the electronic device. The power supply unit 1104 may include a power supply management system, one or more power supplies, and other units related to power generation, management, and allocation.

The audio unit 1105 may be configured to output and/or input audio signals. For example, the audio unit 1105 may include a microphone (MIC). When the electronic apparatus in an operation mode, such as calling mode, recording mode, and voice recognition mode, the MIC may be configured to receive external audio signals. The received audio signals may be further stored in the memory 1101 or sent via the communication unit 1103. In some examples, the audio unit 1105 may further include a speaker configured to output audio signals.

The display unit 1106 may include a screen, which may include liquid crystal display (LCD) and touch panel (TP). If the screen includes a touch panel, the screen may be implemented as touch screen so as to receive input signal from users. The touch panel may include a plurality of touch sensors to sense touching, sliding, and gestures on the touch panel. The touch sensor may not only sense edges of touching or sliding actions, but also sense period and pressure related to the touching or sliding operations.

The above memory 1101, processor 1102, communication unit 1103, power supply unit 1104, audio unit 1105 and display unit 1106 may be connected with the chipset 1107. The chipset 1107 may provide interface between the processor 1102 and other units of the electronic apparatus 1100. Furthermore, the chipset 1107 may provide interface for each unit of the electronic apparatus 1100 to access the memory 1101 and communication interface for accessing among units.

In some examples, one or more modules, one or more steps, or one or more processing procedures involved in FIGS. 1 to 12 may be implemented by a computing device with an operating system and hardware configuration.

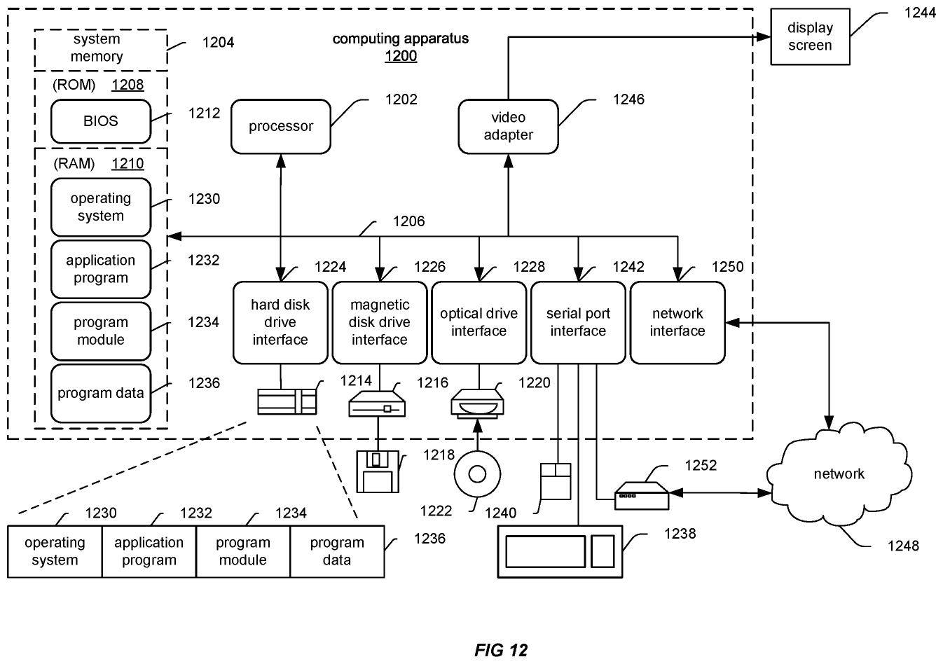

FIG. 12 is a structural block diagram of an exemplary computing apparatus 1200. The description of computing apparatus 1200 provided herein is provided for purposes of illustration, and is not intended to be limiting. Embodiments may be implemented in further types of computer systems, as would be known to persons skilled in the relevant art(s).

As shown in FIG. 12, the computing apparatus 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208, and random access memory (RAM) 1210. A basic input/output system 1212 (BIOS) is stored in ROM 1208.

The computing apparatus 1200 also has one or more of the following drives: a hard disk drive 1212 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1212, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, RAMs, ROMs, and the like.

A number of program modules may be stored on the hard disk, magnetic disk, optical disk, ROM, or RAM. These programs include an operating system 1230, one or more application programs 1232, other program modules 1234, and program data 1236. These programs may include, for example, computer program logic (e.g., computer program code or instructions) for implementing processing procedures, processing logics, and program modules performed in the examples shown in FIG. 1 to FIG. 12.

A user may enter commands and information into computing apparatus 1200 through input devices such as a keyboard 1238 and a pointing device 1240. Other input devices (not shown) may include a microphone, joystick, game pad, satellite dish, scanner, a touch screen and/or touch pad, a voice recognition system to receive voice input, a gesture recognition system to receive gesture input, or the like. These and other input devices may be connected to processor 1202 through a serial port interface 1242 that is coupled to bus 1206, but may be connected by other interfaces, such as a parallel port, game port, or a universal serial bus (USB).

A display screen 1244 is also connected to bus 1206 via an interface, such as a video adapter 1246. Display screen 1244 may be external to, or incorporated in computing apparatus 1200. Display screen 1244 may display information, as well as being a user interface for receiving user commands and/or other information (e.g., by touch, finger gestures, virtual keyboard, etc.). In addition to display screen 1244, the computing apparatus 1200 may include other peripheral output devices (not shown) such as speakers and printers.

The computing apparatus 1200 is connected to a network 1248 (e.g., the Internet) through an adaptor or network interface 1250, a modem 1252, or other means for establishing communications over the network. Modem 1252, which may be internal or external, may be connected to bus 1206 via serial port interface 1242, as shown in FIG. 12, or may be connected to bus 1206 using another interface type, including a parallel interface.

As used herein, the terms “computer program medium,” “computer-readable medium,” and “computer-readable storage medium” are used to generally refer to media such as the hard disk associated with hard disk drive 1212, removable magnetic disk 1218, removable optical disk 1222, system memory 1204, flash memory cards, digital video disks, RAMs, ROMs, and further types of physical/tangible storage media. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250, serial port interface 1242, or any other interface type. Such computer programs, when executed or loaded by an application, enable computing apparatus 1200 to implement features of embodiments discussed herein. Accordingly, such computer programs represent controllers of the computing apparatus 1400.

As such, embodiments are also directed to computer program products including computer instructions/code stored on any computer useable storage medium. Such code/instructions, when executed in one or more data processing devices, causes a data processing device(s) to operate as described herein. Examples of computer-readable storage devices that may include computer readable storage media include storage devices such as

RAM, hard drives, floppy disk drives, CD ROM drives, DVD ROM drives, zip disk drives, tape drives, magnetic storage device drives, optical storage device drives, MEMs devices, nanotechnology-based storage devices, and further types of physical/tangible computer readable storage devices.

### Example Clauses

A. A method, including:
detecting an interest in reading news on user's at least one query during a conversation; and
performing searching for a news content according to a user's query related to the interest in reading news, if it is determined that the interest in reading news is found, and outputting the found news content as a reply in the conversation.

B. The method according to paragraph A, wherein the detecting an interest in reading news on user's at least one query includes:
analyzing the user's current query to determine whether or not the interest in reading news is found, and performing searching for the news content according to the user's current query, if it is determined that the interest in reading news is found; or
acquiring a history of user's queries from a first chatting log, if it is determined that no interest in reading news is found based on the user's current query, determining whether or not the interest in reading news is found based on a combination of the user's current query and the history of user's queries, and performing searching for the news content according to the combination of the user's current query and the history of user's queries, if it is determined that the interest in reading news is found.

C. The method according to paragraph B, wherein the method further includes:
recording the user's current query in the first chatting log, and waiting for a new user's query, if it is determined that no interest in reading news is found based on a combination of the user's current query and the history of user's queries.

D. The method according to paragraph B, wherein if it is determined that no interest in reading news is found based on the user's current query, after acquiring the history of user's queries from the first chatting log, the method further includes:
detecting whether or not a subject of the user's current query and a subject of the history of user's queries meet a similarity condition,
performing the determining whether or not the interest in reading news is found based on a combination of the user's current query and the history of user's queries, if it is determined that the subject of the user's current query and the topic of the history of user's queries meet the similarity condition, and
recording the user's current query in the first chatting log and waiting for an input of a user's new query, if it is determined that the subject of the user's current query and the subject of the history of user's queries fail to meet the similarity condition.

E. The method according to paragraph A, wherein the performing searching for a news content according to a user's query related to the interest in reading news, and outputting the found news content as a reply in the conversation includes:
performing searching for the news content according to the user's related query, and acquiring a plurality of news contents related to the user's query;
performing relevancy ranking on the plurality of news contents by using a relevancy ranking algorithm; and
outputting one or more news contents with high relevancy rankings as a reply in the conversation.

F. The method according to paragraph A, further including:
performing searching for a news comment according to the found news content and the user's related query; and
outputting the acquired news comment as a reply in the conversation.

G. The method according to paragraph F, wherein after the outputting the news comment as a reply in the conversation, the method further includes:
receiving a user's new query, detecting whether or not a subject of the user's new query and a subject of a user's last query meet a subject similarity condition,
performing searching for a new news comment according to the user's new query and the news content, if it is determined that the subject of the user's new query and the subject of the user's last query meet the subject similarity condition, and outputting the acquired new news comment as a reply in the conversation.

H. The method according to paragraph F, wherein after the outputting the news comment as a reply in the conversation, the method further includes:
receiving a user's new query, detecting whether or not a subject of the user's new query and a subject of a user's last query meet a subject similarity condition,
performing a new news comment according to the user's new query and the news content, if it is determined that the subject of the user's new query and the subject of the user's last query meet the subject similarity condition, and outputting the acquired new news comment as a reply in the conversation;
waiting for an input of a user's new query of next round, and
repeating the preceding processing until a preset number of rounds is reached or the subject similarity condition is not met.

I. The method according to paragraph A or F, wherein the outputting the found news content as a reply in the conversation includes:
generating a summary of news according to the found news content, and outputting the summary of news as a reply in the conversation.

J. The method according to paragraph A, further including:
performing chitchat filtering on the received user's query, and
performing the detecting an interest in reading news on user's at least one query, if it is determined that the received user's query is not a user's query of chitchat.

K. The method according to paragraph A, wherein the outputting the found news content as a reply in the conversation includes:
comparing the found news content with an output document in the conversation, and
discarding the news content to be output as a reply in the conversation, if it is determined that there is a news content having a content similarity greater than a preset first threshold, and
outputting the news content as a reply in the conversation, if it is determined that there is a news content having a content similarity smaller than or equal to a preset first threshold.

L. The method according to paragraph A, wherein the outputting the found news content as a reply in the conversation includes:
determining whether or not a number and/or a frequency of outputting the news content exceeds a preset second threshold, and
discarding the news content to be output as a reply in the conversation, if it is determined that the number and/or the frequency of outputting the news content exceeds the preset second threshold, and
outputting the news content as a reply in the conversation, if it is determined that the number and/or the frequency of outputting the news content does not exceed the preset second threshold.

M. The method according to paragraph L, further including:
recording a quantity of read news content and/or a reading time for reading news contents, and
adjusting the second threshold according to the quantity of read news content and/or the reading time for reading news contents.

N. A device, including:
a news reading interest detecting module configured to detect an interest in reading news on user's at least one query during a conversation; and
a news content searching module configured to perform searching for a news content according to a user's query related to the interest in reading news, if the news reading interest detecting module determines that the interest in reading news is found;
a reply outputting module configured to output the found news content as a reply in the conversation.

O. The device according to paragraph N, wherein the news reading interest detecting module includes:
a news reading interest integrity detecting module configured to analyze the user's current query to determine whether or not the interest in reading news is found, wherein the news content searching module performs the performing searching for the news content according to the user's current query, if the news reading interest integrity detecting module determines that the interest in reading news is found; and
a context detecting module configured to acquire a history of user's queries from a first chatting log, if the news reading interest integrity detecting module determines that the interest in reading news is not found based on the user's current query, determine whether or not the interest in reading news is found based on a combination of the user's current query and the history of user's queries, wherein the news content searching module performs the searching for the news content according to the combination of the user's current query and the history of user's queries, if the context detecting module determines that the interest in reading news is found.

P. The device according to paragraph O, wherein the news reading interest detecting module further includes:
a subject consistency determining module configured to determine whether or not a subject of the user's current query and a subject of the history of user's queries meet a similarity condition, wherein
the context detecting module performs the determining whether or not the interest in reading news is found based on a combination of the user's current query and the history of user's queries, if the subject consistency detecting module determines that the subject of the user's current query and the subject of the history of user's queries meet the similarity condition; and
the user's current query is recorded in the first chatting log until a user's new query is input, if the subject consistency detecting module determines that the subject of the user's current query and the subject of the history of user's queries do not meet the similarity condition.

Q. The device according to paragraph N, further including:
a news comment searching module configured to search for a comment on news according to the found news content and the user's related query; and
the reply outputting module is further configured to output the acquired comment on news as a reply in the conversation.

R. The device according to paragraph N, further including:
a chitchat filtering module configured to perform chitchat filtering on the received user's query, wherein
the news reading interest detecting module performs the processing of detecting an interest in reading news on user's at least one query, if the chitchat filtering module determines that the received user's query is not a user's query of chitchat.

S. The device according to paragraph N, further including:
a first output controlling module configured to compare the found news content with an output document in the conversation, wherein
the first output controlling module discards the news content to be output as a reply in the conversation, if the first output controlling module determines that there is a news content having a content similarity greater than a preset first threshold, and
the reply outputting module outputs the news content as a reply in the conversation, if the first output controlling module determines that there is a news content having a content similarity smaller than or equal to a preset first threshold.

T. The device according to paragraph N, further including:
a second output controlling module configured to determine whether or not a number and/or a frequency of outputting the news content exceeds a preset second threshold, wherein
the second output controlling module discards the news content to be output as a reply in the conversation, if the second output controlling module determines that the number and/or the frequency of outputting the news content exceeds the preset second threshold, and
the reply outputting module outputs the news content as a reply in the conversation, if the second output controlling module determines that the number and/or the frequency of outputting the news content does not exceed the preset second threshold.

U. The device according to paragraph T, further including:
a user behavior detecting module configured to record a quantity of read news content and/or a reading time for reading news contents, and adjust the second threshold according to the quantity of read news content and/or the reading time for reading news contents.

V. An electronic apparatus, including:
a processing unit; and
a memory, coupled to the processing unit and containing instructions stored thereon, the instructions cause the electronic apparatus to perform operations upon being executed by the processing unit, the operations include:
detecting an interest in reading news on user's at least one query during a conversation; and
performing searching for a news content according to a user's query related to the interest in reading news, if it is determined that the interest in reading news is found, and outputting the found news content as a reply in the conversation.

W. The electronic apparatus according to paragraph V, wherein the detecting an interest in reading news on user's at least one query includes:
analyzing the user's current query to determine whether or not the interest in reading news is found, and performing searching for the news content according to the user's current query, if it is determined that the interest in reading news is found; or
acquiring a history of user's queries from a first chatting log, if it is determined that no interest in reading news is found based on the user's current query, determining whether or not the interest in reading news is found based on a combination of the user's current query and the history of user's queries, and performing searching for the news content according to the combination of the user's current query and the history of user's queries, if it is determined that the interest in reading news is found.

X. The electronic apparatus according to paragraph V, wherein if it is determined that no interest in reading news is found based on the user's current query, after acquiring the history of user's queries from the first chatting log, the operations further include:
detecting whether or not a subject of the user's current query and a subject of the history of user's queries meet a similarity condition,
performing the determining whether or not the interest in reading news is found based on a combination of the user's current query and the history of user's queries, if it is determined that the subject of the user's current query and the topic of the history of user's queries meet the similarity condition, and
recording the user's current query in the first chatting log and waiting for an input of a user's new query, if it is determined that the subject of the user's current query and the subject of the history of user's queries fail to meet the similarity condition.

Y. The electronic apparatus according to paragraph V, wherein the performing searching for a news content according to a user's query related to the interest in reading news, and outputting the found news content as a reply in the conversation includes:
performing searching for the news content according to the user's related query, and acquiring a plurality of news contents related to the user's query;
performing relevancy ranking on the plurality of news contents by using a relevancy ranking algorithm; and
outputting one or more news contents with high relevancy rankings as a reply in the conversation.

Z. The electronic apparatus according to paragraph V, wherein the operations further include:
performing searching for a news comment according to the found news content and the user's related query; and
outputting the acquired news comment as a reply in the conversation.

A1. The electronic apparatus according to paragraph Z, wherein after the outputting the news comment as a reply in the conversation, the operations further include:
receiving a user's new query, detecting whether or not a subject of the user's new query and a subject of a user's last query meet a subject similarity condition,
performing searching for a new news comment according to the user's new query and the news content, if it is determined that the subject of the user's new query and the subject of the user's last query meet the subject similarity condition, and outputting the acquired new news comment as a reply in the conversation.

A2. The electronic apparatus according to paragraph Z, wherein after the outputting the news comment as a reply in the conversation, the operations further include:
receiving a user's new query, detecting whether or not a subject of the user's new query and a subject of a user's last query meet a subject similarity condition,
performing a new news comment according to the user's new query and the news content, if it is determined that the subject of the user's new query and the subject of the user's last query meet the subject similarity condition, and outputting the acquired new news comment as a reply in the conversation;
waiting for an input of a user's new query of next round, and
repeating the preceding processing until a preset number of rounds is reached or the subject similarity condition is not met.

A3. The electronic apparatus according to paragraph V or Z, wherein the outputting the found news content as a reply in the conversation includes:
generating a summary of news according to the found news content, and outputting the summary of news as a reply in the conversation.

A4. The electronic apparatus according to paragraph V, wherein the operations further include:
performing chitchat filtering on the received user's query, and
performing the detecting an interest in reading news on user's at least one query, if it is determined that the received user's query is not a user's query of chitchat.

A5. The electronic apparatus according to paragraph V, wherein the outputting the found news content as a reply in the conversation includes:
comparing the found news content with an output document in the conversation, and
discarding the news content to be output as a reply in the conversation, if it is determined that there is a news content having a content similarity greater than a preset first threshold, and
outputting the news content as a reply in the conversation, if it is determined that there is a news content having a content similarity smaller than or equal to a preset first threshold.

A6. The electronic apparatus according to paragraph V, wherein the outputting the found news content as a reply in the conversation includes:
determining whether or not a number and/or a frequency of outputting the news content exceeds a preset second threshold, and
discarding the news content to be output as a reply in the conversation, if it is determined that the number and/or the frequency of outputting the news content exceeds the preset second threshold, and
outputting the news content as a reply in the conversation, if it is determined that the number and/or the frequency of outputting the news content does not exceed the preset second threshold.

A7. The electronic apparatus according to paragraph A6, wherein the operations further include:
recording a quantity of read news content and/or a reading time for reading news contents, and
adjusting the second threshold according to the quantity of read news content and/or the reading time for reading news contents.

### Conclusion

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or

“B” or “A and B.”

Reference in the specification to “an implementation”, “one implementation”, “some implementations”, or “other implementations” may mean that a particular feature, structure, or characteristic described in connection with one or more implementations may be included in at least some implementations, but not necessarily in all implementations. The various appearances of “an implementation”, “one implementation”, or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

Conditional language such as, among others, “can,” “could,” “might” or “may,” unless specifically stated otherwise, are otherwise understood within the context as used in general to present that certain examples include, while other examples do not include, certain features, elements and/or steps. Thus, such conditional language is not generally intended to imply that features, elements and/or steps are in any way required for one or more examples or that one or more examples necessarily include logic for deciding, with or without user input or prompting, whether these features, elements and/or steps are included or are to be performed in any particular example.

Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate examples are included within the scope of the examples described herein in which elements or functions can be deleted, or executed out of order from that shown or discussed, including substantially synchronously or in reverse order, depending on the functionality involved as would be understood by those skilled in the art.

It should be emphasized that many variations and modifications can be made to the above-described examples, the elements of which are to be understood as being among other acceptable examples. All such modifications and variations are intended to be included herein within the scope of this disclosure and protected by the following claims

It would be obvious to one skilled in the art that, all or part of steps for implementing the above embodiments may be accomplished by hardware related to programs or instructions. The above program may be stored in a computer readable storing medium. Such program may perform the steps of the above embodiments upon being executed. The above storing medium may include: ROM, RAM, magnetic disk, or optic disk or other medium capable of storing program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

1. A device, comprising:
a news reading interest detecting module configured to detect an interest in reading news on user's at least one query during a conversation; and
a news content searching module configured to perform searching for a news content according to a user's query related to the interest in reading news, if the news reading interest detecting module determines that the interest in reading news is found;
a reply outputting module configured to output the found news content as a reply in the conversation.

2. The device according to claim 1, wherein the news reading interest detecting module comprises:
a news reading interest integrity detecting module configured to analyze the user's current query to determine whether or not the interest in reading news is found, wherein the news content searching module performs the performing searching for the news content according to the user's current query, if the news reading interest integrity detecting module determines that the interest in reading news is found; and
a context detecting module configured to acquire a history of user's queries from a first chatting log, if the news reading interest integrity detecting module determines that the interest in reading news is not found based on the user's current query, determine whether or not the interest in reading news is found based on a combination of the user's current query and the history of user's queries, wherein the news content searching module performs the searching for the news content according to the combination of the user's current query and the history of user's queries, if the context detecting module determines that the interest in reading news is found.

3. The device according to claim 2, wherein the news reading interest detecting module further comprises:
a subject consistency determining module configured to determine whether or not a subject of the user's current query and a subject of the history of user's queries meet a similarity condition, wherein
the context detecting module performs the determining whether or not the interest in reading news is found based on a combination of the user's current query and the history of user's queries, if the subject consistency detecting module determines that the subject of the user's current query and the subject of the history of user's queries meet the similarity condition; and
the user's current query is recorded in the first chatting log until a user's new query is input, if the subject consistency detecting module determines that the subject of the user's current query and the subject of the history of user's queries do not meet the similarity condition.

4. The device according to claim 1, further comprising:
a news comment searching module configured to search for a comment on news according to the found news content and the user's related query; and
the reply outputting module is further configured to output the acquired comment on news as a reply in the conversation.

5. A method, comprising:
detecting an interest in reading news on user's at least one query during a conversation; and
performing searching for a news content according to a user's query related to the interest in reading news, if it is determined that the interest in reading news is found, and outputting the found news content as a reply in the conversation.

6. The method according to claim 5, wherein the detecting an interest in reading news on user's at least one query comprises:
analyzing the user's current query to determine whether or not the interest in reading news is found, and performing searching for the news content according to the user's current query, if it is determined that the interest in reading news is found;
acquiring a history of user's queries from a first chatting log, if it is determined that no interest in reading news is found based on the user's current query, determining whether or not the interest in reading news is found based on a combination of the user's current query and the history of user's queries, and performing searching for the news content according to the combination of the user's current query and the history of user's queries, if it is determined that the interest in reading news is found.

7. The method according to claim 6, wherein the method further comprises:
recording the user's current query in the first chatting log, and waiting for a new user's query, if it is determined that no interest in reading news is found based on a combination of the user's current query and the history of user's queries.

8. The method according to claim 6, wherein if it is determined that no interest in reading news is found based on the user's current query, after acquiring the history of user's queries from the first chatting log, the method further comprises:
detecting whether or not a subject of the user's current query and a subject of the history of user's queries meet a similarity condition,
performing the determining whether or not the interest in reading news is found based on a combination of the user's current query and the history of user's queries, if it is determined that the subject of the user's current query and the topic of the history of user's queries meet the similarity condition, and
recording the user's current query in the first chatting log and waiting for an input of a user's new query, if it is determined that the subject of the user's current query and the subject of the history of user's queries fail to meet the similarity condition.

9. The method according to claim 5, wherein the performing searching for a news content according to a user's query related to the interest in reading news, and outputting the found news content as a reply in the conversation comprises:
performing searching for the news content according to the user's related query, and acquiring a plurality of news contents related to the user's query;
performing relevancy ranking on the plurality of news contents by using a relevancy ranking algorithm; and
outputting one or more news contents with high relevancy rankings as a reply in the conversation.

10. The method according to claim 5, further comprising:
performing searching for a news comment according to the found news content and the user's related query; and
outputting the acquired news comment as a reply in the conversation.

11. The method according to claim 10, wherein after the outputting the news comment as a reply in the conversation, the method further comprises:
receiving a user's new query, detecting whether or not a subject of the user's new query and a subject of a user's last query meet a subject similarity condition,
performing searching for a new news comment according to the user's new query and the news content, if it is determined that the subject of the user's new query and the subject of the user's last query meet the subject similarity condition, and outputting the acquired new news comment as a reply in the conversation.

12. The method according to claim 10, wherein after the outputting the news comment as a reply in the conversation, the method further comprises:
receiving a user's new query, detecting whether or not a subject of the user's new query and a subject of a user's last query meet a subject similarity condition,
performing a new news comment according to the user's new query and the news content, if it is determined that the subject of the user's new query and the subject of the user's last query meet the subject similarity condition, and outputting the acquired new news comment as a reply in the conversation;
waiting for an input of a user's new query of next round, and
repeating the preceding processing until a preset number of rounds is reached or the subject similarity condition is not met.

13. The method according to claim 5, wherein the outputting the found news content as a reply in the conversation comprises:
comparing the found news content with an output document in the conversation, and
discarding the news content to be output as a reply in the conversation, if it is determined that there is a news content having a content similarity greater than a preset first threshold, and
outputting the news content as a reply in the conversation, if it is determined that there is a news content having a content similarity smaller than or equal to a preset first threshold.

14. The method according to claim 5, wherein the outputting the found news content as a reply in the conversation comprises:
determining whether or not a number and/or a frequency of outputting the news content exceeds a preset second threshold, and
discarding the news content to be output as a reply in the conversation, if it is determined that the number and/or the frequency of outputting the news content exceeds the preset second threshold, and
outputting the news content as a reply in the conversation, if it is determined that the number and/or the frequency of outputting the news content does not exceed the preset second threshold.

15. An electronic apparatus, comprising:
a processing unit; and
a memory, coupled to the processing unit and containing instructions stored thereon, the instructions cause the electronic apparatus to perform operations upon being executed by the processing unit, the operations comprise:
detecting an interest in reading news on user's at least one query during a conversation; and
performing searching for a news content according to a user's query related to the interest in reading news, if it is determined that the interest in reading news is found, and outputting the found news content as a reply in the conversation.
